(19) United States
(12) Patent Application Publication
(10) Pub. No.: US 2021/0224598 A1
(43) Pub. Date: Jul. 22, 2021

(54) METHOD FOR TRAINING DEEP LEARNING MODEL, ELECTRONIC EQUIPMENT, AND STORAGE MEDIUM

(71) Applicant: Beijing SenseTime Technology Development Co., Ltd., Beijing (CN)

(72) Inventor: Jiahui LI, Beijing (CN)

(21) Appl. No.: 17/225,368

(22) Filed: Apr. 8, 2021

Related U.S. Application Data
(63) Continuation of application No. PCT/CN2019/114497, filed on Oct. 30, 2019.

(30) Foreign Application Priority Data
Dec. 29, 2018 (CN) 201811646736.0

(51) Int. Cl. G06K 9/62; G06N 3/08; G06N 3/04; G06T 7/12

(52) U.S. Cl. CPC G06K 9/6256; G06N 3/08; G06T 2207/20084; G06T 7/12; G06T 2207/20081; G06N 3/0454

(57) ABSTRACT

A method for training a deep learning model includes: acquiring (n+1)th first label information output by a first model, the first model having been subject to n rounds of training, and acquiring (n+1)th second label information output by a second model, the second model having been subject to n rounds of training, the n being an integer greater than 1; generating an (n+1)th training set of the second model based on training data and the (n+1)th first label information, and generating an (n+1)th training set of the first model based on the training data and the (n+1)th second label information; performing an (n+1)th round of training on the second model by inputting the (n+1)th training set of the second model to the second model, and performing the (n+1)th round of training on the first model by inputting the (n+1)th training set of the first model to the first model.

### CROSS-REFERENCE TO RELATED APPLICATIONS

This application is a continuation of International Patent Application No. PCT/CN2019/114497, filed on Oct. 30, 2019, which claims priority to Chinese Application No. 201811646736.0, filed on Dec. 29, 2018. The disclosures of International Patent Application No. PCT/CN2019/114497 and Chinese Application No. 201811646736.0 are hereby incorporated by reference in their entireties.

### TECHNICAL FIELD

The subject disclosure relates, but is not limited, to the field of information technology, and more particularly, to a method and device for training a deep learning model, electronic equipment, and a storage medium.

### BACKGROUND

After being trained with a training set, a deep learning model may have certain classification or identification capability. The training set may generally include training data and label data of the training data. However, in general, the data may have to be labeled manually. On one hand, pure manual labeling of all training data is of a heavy workload and low efficiency, and there may be a human error in the labeling. On the other hand, high-precision labeling such as labeling in the field of images may require pixel-level segmentation, which is difficult to achieve by pure manual labeling, and the labeling precision thereof is hardly guaranteed.

Therefore, it is inefficient to train a deep learning model based on training data purely manually labeled. The trained model may not reach expected precision in terms of its classification or identification capability, due to low precision of the training data per se.

### SUMMARY

In view of this, embodiments herein serve to provide a method and device for training a deep learning model, electronic equipment, and a storage medium.

A technical solution herein is implemented as follows.

According to a first aspect herein, a method for training a deep learning model includes:
acquiring (n+1)th first label information output by a first model, the first model having been subject to n rounds of training, and acquiring (n+1)th second label information output by a second model, the second model having been subject to n rounds of training, the n being an integer greater than 1;
generating an (n+1)th training set of the second model based on training data and the (n+1)th first label information, and generating an (n+1)th training set of the first model based on the training data and the (n+1)th second label information;
performing an (n+1)th round of training on the second model by inputting the (n+1)th training set of the second model to the second model, and performing the (n+1)th round of training on the first model by inputting the (n+1)th training set of the first model to the first model.

Based on the solution, the method may include:
determining whether the n is less than N, the N being a maximal number of rounds of training.

Acquiring the (n+1)th first label information output by the first model and acquiring the (n+1)th second label information output by the second model may include:
in response to the n being less than the N, acquiring the (n+1)th first label information output by the first model and acquiring the (n+1)th second label information output by the second model.

Based on the solution, acquiring the training data and the initial label information of the training data may include:
acquiring a training image containing a plurality of segmentation target, and acquiring a circumscribing frame circumscribing the segmentation target,
Generating the first training set of the first model and the first training set of the second model based on the initial label information may include:
based on the circumscribing frame, drawing, inside the circumscribing frame, a label contour shaped like the segmentation target; and
generating the first training set of the first model and the first training set of the second model based on the training data and the label contour.

Based on the solution, generating the first training set of the first model and the first training set of the second model based on the initial label information may further include:
generating, based on the circumscribing frame, a segmentation boundary between two of the segmentation target that overlap each other; and
generating the first training set of the first model and the first training set of the second model based on the training data and the segmentation boundary.

Based on the solution, based on the circumscribing frame, drawing, inside the circumscribing frame, the label contour shaped like the segmentation target may include:
based on the circumscribing frame, drawing, inside the circumscribing frame, an inscribed ellipse inscribed in the circumscribing frame, the inscribed ellipse being shaped like a cell.

According to a second aspect herein, a device for training a deep learning model includes a label module, a first generating module, and a training module.

The label module is adapted to: acquire (n+1)th first label information output by a first model, the first model having been subject to n rounds of training, and acquire (n+1)th second label information output by a second model, the second model having been subject to n rounds of training. The n is an integer greater than 1.

The first generating module is adapted to: generate an (n+1)th training set of the second model based on training data and the (n+1)th first label information, and generate an (n+1)th training set of the first model based on the training data and the (n+1)th second label information.

The training module is adapted to: perform an (n+1)th round of training on the second model by inputting the (n+1)th training set of the second model to the second model, and perform the (n+1)th round of training on the first model by inputting the (n+1)th training set of the first model to the first model.

Based on the solution, the device may include a determining module.

The determining module may be adapted to determine whether the n is less than N. The N may be a maximal number of rounds of training.

The label module may be adapted to, in response to the n being less than the N, acquire the (n+1)th first label information output by the first model and acquire the (n+1)th second label information output by the second model.

Based on the solution, the device may include an acquiring module and a second generating module.

The acquiring module may be adapted to acquire the training data and initial label information of the training data.

The second generating module may be adapted to generate a first training set of the first model and a first training set of the second model based on the initial label information.

Based on the solution, the acquiring module may be adapted to acquire a training image containing a plurality of segmentation target, and acquire a circumscribing frame circumscribing the segmentation target.

The second generating module may be adapted to: based on the circumscribing frame, draw, inside the circumscribing frame, a label contour shaped like the segmentation target; and generate the first training set of the first model and the first training set of the second model based on the training data and the label contour.

Based on the solution, the first generating module may be adapted to: generate, based on the circumscribing frame, a segmentation boundary between two of the segmentation target that overlap each other; and generate the first training set of the first model and the first training set of the second model based on the training data and the segmentation boundary.

Based on the solution, the second generating module may be adapted to, based on the circumscribing frame, draw, inside the circumscribing frame, an inscribed ellipse inscribed in the circumscribing frame, the inscribed ellipse being shaped like a cell.

According to a third aspect herein, a computer-readable storage medium has stored thereon computer-executable instructions which, when executed, implement any aforementioned method for training a deep learning model herein.

According to a fourth aspect herein, electronic equipment includes memory and a processor connected to the memory.

The processor is adapted to implement, by executing computer-executable instructions stored in the memory, any aforementioned method for training a deep learning model herein.

According to a fifth aspect herein, a computer program product includes computer-executable instructions which, when executed, implement any aforementioned method for training a deep learning model herein.

With a technical solution herein, label information is acquired by labeling training data using a deep learning model having been subject to a last round of training The label information is used as a training sample for the next round of training of another model. Model training may be performed by using very few initial training data labeled manually. Label data identified and output by each of a first model and a second model gradually converging are used as the training sample for the next round of training of the other model. A model parameter of a deep learning model during the last round of training is generated according to most correctly labeled data. A few incorrectly labeled or imprecise data have limited impact on the model parameter of the deep learning model. The precision of label information output by the deep learning model improves with the number of iterations. The label information with an improving precision is taken as training data, improving a training result of training the deep learning model. A model constructs a training sample using labeling information from the model per se, reducing the amount of data to be labeled manually, avoiding imprecise manual labeling as well as a human error, with a high model training speed and a good training result. In addition, a deep learning model trained in this manner may achieve a high classification or identification precision. Moreover, in the embodiments, at least two models are trained at the same time, avoiding abnormal learning of the final deep learning model caused by learning and iterating an error by the single model. In the embodiments, a result of labeling training data by a model having subject to the last round of training is used in the next round of training of another model. Accordingly, two models are used to prepare data for the next round of training for each other, avoiding strengthening of an error due to iteration of a single model, thereby reducing an error in model learning, improving the result of training a deep learning model.

### BRIEF DESCRIPTION OF THE ACCOMPANYING DRAWINGS

FIG. 1 is a flowchart of a first method for training a deep learning model according to an embodiment herein.

FIG. 2 is a flowchart of a second method for training a deep learning model according to an embodiment herein.

FIG. 3 is a flowchart of a third method for training a deep learning model according to an embodiment herein.

FIG. 4 is a diagram of a structure of a device for training a deep learning model according to an embodiment herein.

FIG. 5 is a diagram of change in a training set according to an embodiment herein.

FIG. 6 is a diagram of electronic equipment according to an embodiment herein.

### DETAILED DESCRIPTION

A technical solution herein is further elaborated below with reference to the drawings and embodiments.

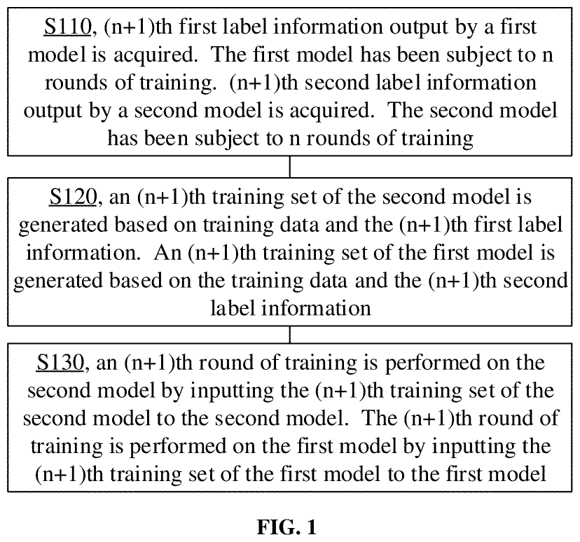

As shown in FIG. 1, embodiments herein provide a method for training a deep learning model, including steps as follows.

In step S110, (n+1)th first label information output by a first model is acquired. The first model has been subject to n rounds of training. (n+1)th second label information output by a second model is acquired. The second model has been subject to n rounds of training. The n is an integer greater than 1.

In step S120, an (n+1)th training set of the second model is generated based on training data and the (n+1)th first label information. An (n+1)th training set of the first model is generated based on the training data and the (n+1)th second label information.

In step S130, an (n+1)th round of training is performed on the second model by inputting the (n+1)th training set of the second model to the second model. The (n+1)th round of training is performed on the first model by inputting the (n+1)th training set of the first model to the first model.

A method for training a deep learning model herein may be used in all sorts of electronic equipment, such as a server for training various big data models.

In embodiments herein, all first label information and second label information may include, but is not limited to, label information for an image. The image may include a medical image, etc. The medical image may be a 2D medical image, or a 3D medical image made up of an image sequence formed by multiple 2D images.

Respective first label information and second label information may label an organ and/or a tissue in a medical image, as well as distinct cell structures in a cell, such as a nucleus.

In S110 herein, training data may be processed using the first model that has been subject to n rounds of training. In this case, the first model may output the (n+1)th first label data. The (n+1)th first label data may correspond to the training data, forming the (n+1)th training set of the second model.

Likewise, in S110, training data may be processed using the second model that has been subject to n rounds of training. In this case, the second model may output the (n+1)th second label data. The (n+1)th second label data may correspond to the training data, forming the (n+1)th training set of the first model.

In embodiments herein, all the first label data may be label information acquired by identifying or classifying the training data using the first model. The second label information may be label information acquired by identifying or classifying the training data using the second model. In the embodiments, the (n+1)th first label data may be used for the (n+1)th round of training of the second model, while the (n+1)th second label data may be used for the (n+1)th round of training of the first model.

In this way, in the embodiments, training samples for the (n+1)th round of training of the first model and the second model may be generated automatically. Accordingly, a user does not have to manually label the training set for the (n+1)th round of training, saving time spent manually labeling the samples, increasing a rate of training a deep learning model, reducing imprecise classification or identification by the trained deep learning model caused by inaccurate or imprecise manual labeling, increasing precision of classification or identification by the trained deep learning model.

Moreover, in the embodiments, the first label data of the first model may be used for training the second model, while the second label data of the second model may be used for training the first model, thereby suppressing error strengthening in model training caused by using label data from the first model per se for the next round of training of the first model, thereby improving the result of training the first model and the second model.

In some embodiments, the first model and the second model may refer to two independent models. However, the two models may or may not be the same. For example, the first model and the second model may be deep learning models of the same type, or of different types.

In some embodiments, the first model and the second model may be deep learning models of different network structures. For example, the first model may be a fully connected convolutional neural network (FNN), while the second model may be a common convolutional neural network (CNN). As another example, the first model may be a recurrent neural network (RNN), while the second model may be an FNN or a CNN. As yet another example, the first model may be a V-NET, while the second model may be a U-NET, etc.

If the first model differs from the second model, the probability that the first model and the second model generate the same error based on the same first training set in training may be reduced greatly, further suppressing strengthening by the first model and the second model due to identical errors during iteration, improving a training result again.

In the embodiments, completing a round of training may include that both the first model and the second model learn each training sample in their respective training sets for at least one time.

For example, the training data may be S images. The first training sample may be the S images and the result of manually labeling the S images. Labeling of one image in the S images may be imprecise. However, during the first round of training of the first model and the second model, structures of the other S-1 images may be labeled with a precision that reaches an expected threshold. Then, the S-1 images and label data corresponding to the S-1 images may have greater influence on model parameters of the first model and the second model. In the embodiments, the deep learning models may include, but is not limited to, neural networks. The model parameters may include, but are not limited to, weights and/or thresholds of nodes in the neural networks. The neural networks may be various types of neural networks, such as U-nets or V-nets. The neural networks may include a coding part for performing feature extraction on the training data, and a decoding part for acquiring semantic information based on an extracted feature. For example, with the coding part, feature extraction may be performed on a region including a segmentation target in an image, etc., acquiring a mask image differentiating the segmentation target from the background. A decoder may acquire some semantic information based on the mask image. For example, an omics feature of the target, etc., may be acquired by counting pixels, etc. The omics feature may include a morphological feature, such as an area, a volume, a shape, etc., of the target, and/or a gray scale feature formed based on a gray scale, etc. The gray scale feature may include a statistical feature of a histogram, etc.

In short, in the embodiments, in identifying the S images, the first model and the second model that have been subject to the first round of training may automatically label the image with an insufficient labeling precision using a network parameter learnt from the other S-1 images. In this case, the labeling precision may be close to those of the other S-1 images. Therefore, the precision of the second label information corresponding to the image may be improved compared to that of the original first label information. The second training set of the first model thus formed may include S images and training data formed by the first label information generated by the second model. In this way, the second training set of the second model may include training data and the first label information from the first model. An error A may occur in the first round of training of the first model, and yet training data and the second label information output by the second model are used in the second round of training. Then, if the error A does not occur in the second model, the second label information will not be affected by the error A. In this way, strengthening of the error A in the first model may be suppressed by performing the second round of training on the first model using the second label information from the second model. Therefore, in the embodiments, negative impact of an insufficient initial labeling precision or an incorrect training sample may be suppressed gradually since the first model and the second model may learn based on most correct or high-precision label information. Moreover, the next round of training of one of the two models is performed using labeling data from the other, not only reducing manual labeling of training samples greatly, but also improving the training precision gradually by characteristics of self-iteration, thereby achieving expected precisions of the trained first model and the trained second model.

In the examples, the training data may be images. In some embodiments, the training data my also be voice clips, text information, etc., other than images. In sort, there may be various forms of training data, which are not limited to any one type herein.

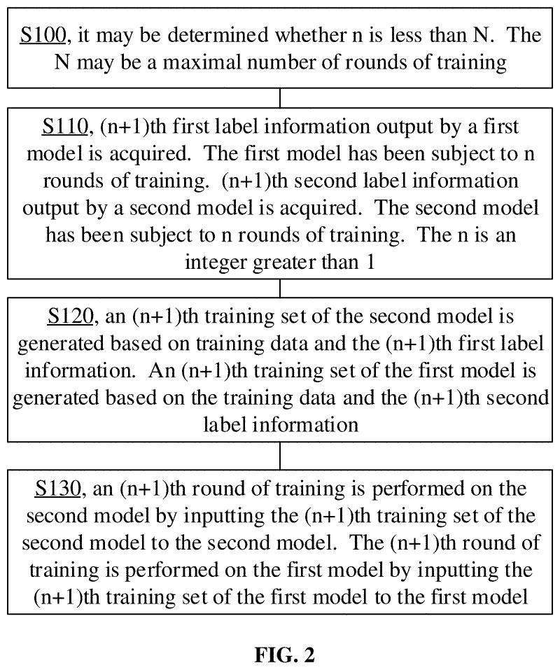

In some embodiments, as shown in FIG. 2, the method may include a step as follows.

In step S100, it may be determined whether the n is less than N. The N may be a maximal number of rounds of training.

The step S110 may include a step as follows.

If the n is less than the N, the (n+1)th first label information may be acquired by labeling the training data using the first model that has been subject to the nth training, and the (n+1)th second label information may be acquired by labeling the training data using the second model that has been subject to the nth training.

In the embodiments, before constructing the (n+1)th training set, it may first be determined whether the number of completed rounds of training has reached the preset maximal number of rounds of training., The (n+1)th label information may be generated to construct the (n+1)th training set of the first model and the (n+1)th training set of the second model only if the number of completed rounds of training has not reached the preset maximal number of rounds of training. Otherwise, it may be determined that model training is completed, and training of the deep learning models may be stopped.

In some embodiments, the N may be an experience value, such as 4, 5, 6, 7, or 8, etc., or a statistical value.

In some embodiments, the N may range from 3 to 10. The N may be a value input by a user as received by training equipment from a human-computer interaction interface.

In some embodiments, it may be determined whether to stop training as follows.

The first model and the second model may be tested using a test set. If the test result indicates that the first model and the second model label test data in the test set with a satisfactory precision, training of the first model and the second model may be stopped. Otherwise, the flow may go to the step S110 to enter the next round of training. In this case, the test set may be a data set labeled precisely, and therefore may be used to measure a training result of each round of training the first model and the second model, to determine whether to stop training the first model and the second model.

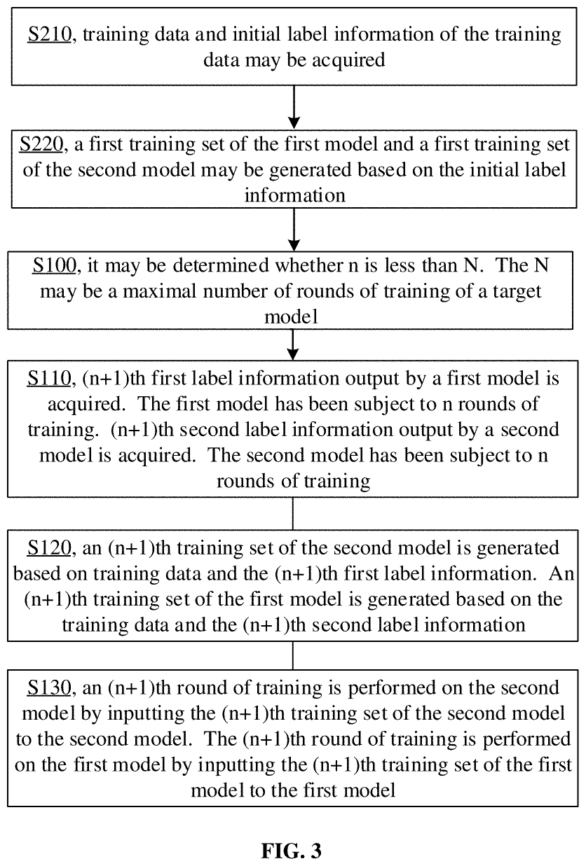

In some embodiments, as shown in FIG. 3, the method may include a step as follows.

In step S210, the training data and initial label information of the training data may be acquired.

In step S220, a first training set of the first model and a first training set of the second model may be generated based on the initial label information.

In the embodiments, the initial label information may be original label information of the training data. The original label information may be manual label information, or information labeled by other equipment, such as information labeled by other equipment with certain labeling capability.

In the embodiments, after the training data and the initial label information have been acquired, the 1st first label information and the 1st second label information may be acquired based on the initial label information. The 1st first label information and the 1st second label information may directly include the initial label information and/or refined label information generated according to the initial label information.

For example, assume that the training data are of an image. The image may contain a cell image. The initial label information may be label information labeling the approximate location of the cell image, while the refined label information may be a location label indicating the refined location of the cell image. In short, in the embodiments, the initial label information may label a segmentation object more precisely than the initial label information does.

In this way, even if the initial label information is acquired manually, the manual labeling may be done with reduced difficulty, simplifying the manual labeling.

Take a cell image as an example. Due to the ellipsoidal morphology of a cell, the outer contour of the cell in a 2D planar image may appear oval. The initial label information may be a circumscribing frame circumscribing the cell. The circumscribing frame may be drawn by a doctor manually. The refined label information may be an inscribed ellipse generated by training equipment based on the circumscribing frame resulting from the manual labeling. A number of pixels in the circumscribing frame excluded from the cell image in the inscribed ellipse may be computed. Therefore, the first label information may be more precise than the initial label information.

In some embodiments, the step S210 may include a step as follows. A training image containing a plurality of segmentation targets may be acquired. A circumscribing frame circumscribing a segmentation target may be acquired.

The step S220 may include a step as follows. A label contour shaped like the segmentation target may be drawn inside the circumscribing frame based on the circumscribing frame. The first training set of the first model and the first training set of the second model may be generated based on the training data and the label contour.

In some embodiments, the label contour shaped like the segmentation target may be the oval, a circle, a triangle, or another polygon shaped like the segmentation target, etc.

In some embodiments, the label contour may be inscribed in the circumscribing frame. The circumscribing frame may be a rectangular frame.

In some embodiments, the step S220 may further include a step as follows.

A segmentation boundary between two of the segmentation target that overlap each other may be generated based on the circumscribing frame.

The first training set of the first model and the first training set of the second model may be generated based on the training data and the segmentation boundary.

In some embodiments, the label contour shaped like the segmentation target may be drawn inside the circumscribing frame based on the circumscribing frame, as follows. An inscribed ellipse inscribed in the circumscribing frame may be drawn inside the circumscribing frame based on the circumscribing frame. The inscribed ellipse may be shaped like a cell.

In some image, two segmentation targets may overlap each other. In the embodiments, the first label information may further include a segmentation boundary between the two overlapping segmentation targets.

For example, a cell image A may overlap a cell image B. Then, after the cell boundary of the cell image A and the cell boundary of the cell image B have been drawn, the two cell boundaries may cross each other, forming a part enclosing the overlapping part of the two cell images. In the embodiments, according to a relation between the location of the cell image A and the location of the cell image B, a part of the cell boundary of the cell image B located inside the cell image A may be erased, and a part of the cell boundary of the cell image A located inside the cell image B may be taken as the segmentation boundary.

In short, in the embodiments, the step S220 may include a step as follow. A segmentation boundary may be drawn in an overlapping part of two segmentation targets using a relation between locations of the two segmentation targets.

In some embodiments, a segmentation boundary may be drawn by correcting the boundary of one of two segmentation targets with overlapping boundaries. A boundary may be made bold by pixel expansion to highlight the boundary. For example, the boundary of the cell image A along the overlapping part may be made bold by expanding the cell boundary of the cell image A at the overlapping part toward the cell image B by a preset number of pixels, such as 1 or more pixels, thereby allowing the bold boundary to be identified as the segmentation boundary.

In some embodiments, the label contour shaped like the segmentation target may be drawn inside the circumscribing frame based on the circumscribing frame, as follows. An inscribed ellipse inscribed in the circumscribing frame may be drawn inside the circumscribing frame based on the circumscribing frame. The inscribed ellipse may be shaped like a cell.

In the embodiments, a segmentation target may be a cell image. The label contour may include an inscribed ellipse inscribed in a circumscribing frame that is shaped like a cell.

In the embodiments, the first label information may include at least one of:
the cell boundary of the cell image (corresponding to the inscribed ellipse), or
the segmentation boundary between overlapping cell images.

Assume, in some embodiments, that the segmentation target(s) may be target(s) other than the cell(s). For example, the segmentation targets may be faces in a photo of a group of people. A circumscribing frame circumscribing a face may still be a rectangular frame. However, a label boundary of the face may be a boundary of an oval face, a round face, etc. In this case, the shape is not limited to the inscribed ellipse.

The above are but examples. In short, in the embodiments, each of the first model and the second model may output label information of the training data using the training result of the last round of training of the other model, to construct the training set for the next round. Model training is completed by multiple iterations, avoiding manual labeling of massive training samples, improving a rate of training, as well as improving a precision of training by iteration.

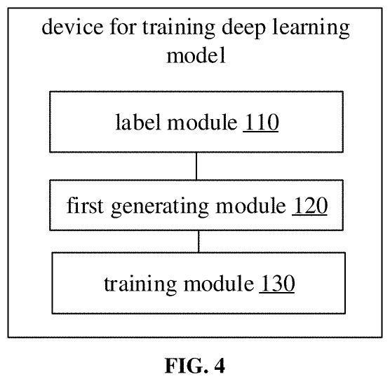

As shown in FIG. 4, a structure of a device for training a deep learning model according to an embodiment herein includes g a label module, a first generating module, and a training module.

The label module 110 is adapted to: acquire (n+1)th first label information output by a first model, the first model having been subject to n rounds of training, and acquire (n+1)th second label information output by a second model, the second model having been subject to n rounds of training. The n is an integer greater than 1.

The first generating module 120 is adapted to: generate an (n+1)th training set of the second model based on training data and the (n+1)th first label information, and generate an (n+1)th training set of the first model based on the training data and the (n+1)th second label information.

The training module 130 is adapted to: perform an (n+1)th round of training on the second model by inputting the (n+1)th training set of the second model to the second model, and perform the (n+1)th round of training on the first model by inputting the (n+1)th training set of the first model to the first model.

In some embodiments, the label module 110, the first generating module 120, and the training module 130 may be program modules which, when executed, implement the operations.

In some embodiments, the label module 110, the first generating module 120, and the training module 130 may be models combining hardware and software. The models combining hardware and software may be various programmable arrays such as field-programmable arrays or complex programmable arrays.

In some other embodiments, the label module 110, the first generating module 120, and the training module 130 may be pure hardware modules. The pure hardware modules may be s application-specific integrated circuits (ASIC).

In some embodiments, the device may include a determining module.

The determining module may be adapted to determine whether the n is less than N. The N may be a maximal number of rounds of training.

The label module may be adapted to, in response to the n being less than the N, acquire the (n+1)th first label information output by the first model and acquire the (n+1)th second label information output by the second model.

In some embodiments, the device may include an acquiring module and a second generating module.

The acquiring module may be adapted to acquire the training data and initial label information of the training data.

The second generating module may be adapted to generate a first training set of the first model and a first training set of the second model based on the initial label information.

In some embodiments, the acquiring module may be adapted to acquire a training image containing a plurality of segmentation target, and acquiring a circumscribing frame circumscribing the segmentation target.

The second generating module may be adapted to: based on the circumscribing frame, draw, inside the circumscribing frame, a label contour shaped like the segmentation target; and generate the first training set of the first model and the first training set of the second model based on the training data and the label contour.

In some embodiments, the first generating module may be adapted to: generate, based on the circumscribing frame, a segmentation boundary between two of the segmentation target that overlap each other; and generate the first training set of the first model and the first training set of the second model based on the training data and the segmentation boundary.

In some embodiments, the second generating module may be adapted to, based on the circumscribing frame, draw, inside the circumscribing frame, an inscribed ellipse inscribed in the circumscribing frame. The inscribed ellipse may be shaped like a cell.

A specific example is provided as follows with reference to the embodiments.

### EXAMPLE 1

In weakly supervised mutual learning, two models may learn from each other by taking rectangular frames enclosing some objects in an image as an input, allowing output of a segmentation result of segmenting pixels of the objects in another unknown image.

Taking cell segmentation as an example, at first, there may be rectangular labels enclosing some cells in an image. It may be observed that most cells are ellipses. Then, a maximal inscribed ellipse inscribed in a rectangle may be drawn. A segmenting line/lines segmenting distinct ellipses may be drawn. Segmenting lines may also be drawn along edges of ellipses. These may serve as an initial supervising signal. Two segmentation models may be trained. Then, predictions regarding the image may be made using the segmentation models. A union of the resulting predicted image and the initial labeled image may be acquired as a new supervising signal. Each of the segmentation models may be trained again using an integrated result of the other. Thus, one may find an improving result of segmenting the image.

Using the method in the same way, first, one prediction result may be made using each of two models. Then, prediction by each model may be repeated using the prediction result of the other.

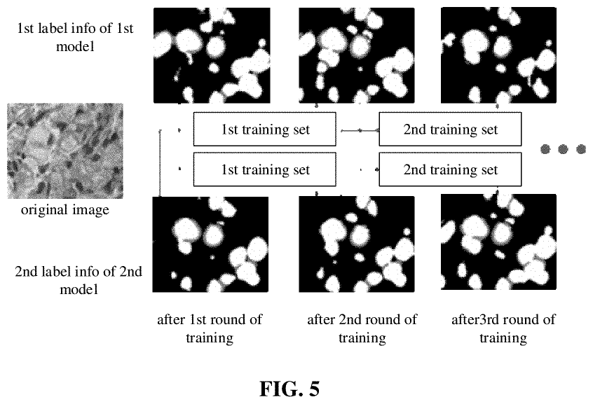

As shown in FIG. 5, an original image may be labeled. A mask image may be acquired by a second model to construct a first training set of a first model and a first training set of the second model. A first round of training of the first model and the second model may be performed respectively using the first training sets. After the first round of training has been completed, the image may be identified using the first model, acquiring label information. A second training set of the second model may be generated using the label information. In addition, after the first round of training has been completed, the image may be identified using the second model, acquiring label information. A second training set of the first model may be generated using the label information. A second round of training of the first model and the second model may be performed, respectively. The training set of one model may be formed repeated using label information from the other model, and multiple rounds of iterating training may be performed. Then, the training may stop.

In related art, complicated consideration of a probability plot of the result of a first segmentation is always made. Analysis of such as a peak, a flat region, etc., is performed. Then, regional growth, etc., may be performed. For a reader, the amount of work for reproducing the result is large, and the implementation is difficult. With the method for training a deep learning model according to the example, no computation is done on an output segmentation probability plot. A union of the probability plot and a labeled image may be acquired directly. Then, the model training continues. Implementation of the process is simple.

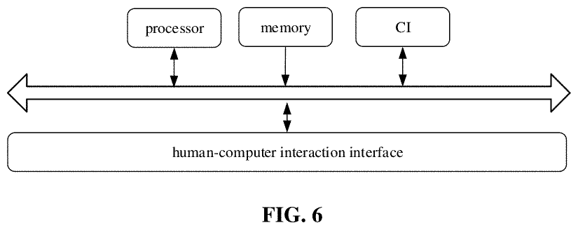

As shown in FIG. 6, embodiments herein provide electronic equipment, including memory and a processor.

The memory is adapted to store information.

The processor is connected to the memory, and is adapted to implement, by executing computer-executable instructions stored in the memory, the method for training a deep learning model provided by one or more technical solutions herein, such as one or more methods as shown in FIG. 1 to FIG. 3.

The memory may be memory of various types, such as Random Access Memory (RAM), Read-Only Memory (ROM), flash memory, etc. The memory may be adapted to store information such as computer-executable instructions, etc. The computer-executable instructions may be program instructions of various types, such as object program instructions and/or source code instructions, etc.

The processor may be a processor of various types, such as a Central Processing Unit (CPU), a Micro Processing Unit (MPU), a Digital Signal Processor (DSP), a programmable array, a specific integrated circuit, an image processor, etc.

The processor may be connected to the memory via a bus. The bus may be an Integrated Circuit bus, etc.

In some embodiments, the user equipment may further include a communication interface (CI). The CI may include a network interface such as a local area network (LAN) interface, a transceiver antenna, etc. the CI may be connected to the processor, too, and may be adapted to transmit and receive information.

In some embodiments, the electronic equipment may further include a camera. The camera may collect various images such as medical images, etc.

In some embodiments, the UE may further include a human-computer interaction interface. For example, the human-computer interaction interface may include various input/output (I/O) equipment, such as a keyboard, a touch screen, etc.

Embodiments herein provide a computer-readable storage medium. The computer-readable storage medium has stored thereon a computer-executable code which, when executed, implements the method for training a deep learning model provided by one or more technical solutions herein, such as one or more methods as shown in FIG. 1 to FIG. 3.

The storage medium may include various media capable of storing a program code, such as mobile storage equipment, Read-Only Memory (ROM), Random Access Memory (RAM), a magnetic disk, a CD, and/or the like. The storage medium may be a non-transitory storage medium.

Embodiments herein provide a computer program product. The computer program product includes computer-executable instructions which, when executed, implement the method for training a deep learning model according to any embodiment herein, such as one or more methods as shown in FIG. 1 to FIG. 3.

Note that in embodiments provided herein, the disclosed equipment and method may be implemented in other ways. The described equipment embodiments are merely exemplary. For example, the unit division is merely logical function division and can be other division in actual implementation. For example, multiple units or components can be combined, or integrated into another system, or some features/characteristics can be omitted or skipped. Furthermore, the coupling, or direct coupling or communicational connection among the components illustrated or discussed herein may be implemented through indirect coupling or communicational connection among some interfaces, equipment, or units, and may be electrical, mechanical, or in other forms.

The units described as separate components may or may not be physically separated. Components shown as units may be or may not be physical units. They may be located in one place, or distributed on multiple network units. Some or all of the units may be selected to achieve the purpose of a solution of the present embodiments as needed.

In addition, various functional units in each embodiment of the subject disclosure may be integrated in one processing unit, or exist as separate units respectively; or two or more such units may be integrated in one unit. The integrated unit may be implemented in form of hardware, or hardware plus software functional unit(s).

A skilled person in the art may understand that all or part of the steps of the embodiments may be implemented by instructing a related hardware through a program, which program may be stored in a (non-transitory) computer-readable storage medium and when executed, execute steps including those of the embodiments. The computer-readable storage medium may be various media that can store program codes, such as mobile storage equipment, Read Only Memory (ROM), a magnetic disk, a CD, and/or the like.

What described are but embodiments herein and are not intended to limit the scope of the subject disclosure. Any modification, equivalent replacement, and/or the like made within the technical scope of the subject disclosure, as may occur to a person having ordinary skill in the art, shall be included in the scope of the subject disclosure. The scope of the subject disclosure thus should be determined by the claims.

What is claimed is:

1. A method for training a deep learning model, comprising:
acquiring (n+1)th first label information output by a first model, the first model having been subject to n rounds of training, and acquiring (n+1)th second label information output by a second model, the second model having been subject to n rounds of training, the n being an integer greater than 1;
generating an (n+1)th training set of the second model based on training data and the (n+1)th first label information, and generating an (n+1)th training set of the first model based on the training data and the (n+1)th second label information; and
performing an (n+1)th round of training on the second model by inputting the (n+1)th training set of the second model to the second model, and performing the (n+1)th round of training on the first model by inputting the (n+1)th training set of the first model to the first model.

2. The method of claim 1, comprising:
determining whether the n is less than N, the N being a maximal number of rounds of training,
wherein acquiring the (n+1)th first label information output by the first model and acquiring the (n+1)th second label information output by the second model comprises:
in response to the n being less than the N, acquiring the (n+1)th first label information output by the first model and acquiring the (n+1)th second label information output by the second model.

3. The method of claim 1, comprising:
acquiring the training data and initial label information of the training data; and
generating a first training set of the first model and a first training set of the second model based on the initial label information.

4. The method of claim 3,
wherein acquiring the training data and the initial label information of the training data comprises:
acquiring a training image containing a plurality of segmentation target, and acquiring a circumscribing frame circumscribing the segmentation target,
wherein generating the first training set of the first model and the first training set of the second model based on the initial label information comprises:
based on the circumscribing frame, drawing, inside the circumscribing frame, a label contour shaped like the segmentation target; and
generating the first training set of the first model and the first training set of the second model based on the training data and the label contour.

5. The method of claim 4, wherein generating the first training set of the first model and the first training set of the second model based on the initial label information comprises:
generating, based on the circumscribing frame, a segmentation boundary between two of the segmentation target that overlap each other; and
generating the first training set of the first model and the first training set of the second model based on the training data and the segmentation boundary.

6. The method of claim 4,
wherein based on the circumscribing frame, drawing, inside the circumscribing frame, the label contour shaped like the segmentation target comprises:
based on the circumscribing frame, drawing, inside the circumscribing frame, an inscribed ellipse inscribed in the circumscribing frame, the inscribed ellipse being shaped like a cell.

7. The method of claim 2, comprising:
acquiring the training data and initial label information of the training data; and
generating a first training set of the first model and a first training set of the second model based on the initial label information.

8. The method of claim 7,
wherein acquiring the training data and the initial label information of the training data comprises:
acquiring a training image containing a plurality of segmentation target, and acquiring a circumscribing frame circumscribing the segmentation target,
wherein generating the first training set of the first model and the first training set of the second model based on the initial label information comprises:
based on the circumscribing frame, drawing, inside the circumscribing frame, a label contour shaped like the segmentation target; and
generating the first training set of the first model and the first training set of the second model based on the training data and the label contour.

9. The method of claim 8, wherein generating the first training set of the first model and the first training set of the second model based on the initial label information comprises:
generating, based on the circumscribing frame, a segmentation boundary between two of the segmentation target that overlap each other; and
generating the first training set of the first model and the first training set of the second model based on the training data and the segmentation boundary.

10. The method of claim 8,
wherein based on the circumscribing frame, drawing, inside the circumscribing frame, the label contour shaped like the segmentation target comprises:
based on the circumscribing frame, drawing, inside the circumscribing frame, an inscribed ellipse inscribed in the circumscribing frame, the inscribed ellipse being shaped like a cell.

11. Electronic equipment, comprising memory and a processor connected to the memory,
wherein the processor is adapted, by executing computer-executable instructions stored in the memory, to:
acquire (n+1)th first label information output by a first model, the first model having been subject to n rounds of training, and acquiring (n+1)th second label information output by a second model, the second model having been subject to n rounds of training, the n being an integer greater than 1;
generate an (n+1)th training set of the second model based on training data and the (n+1)th first label information, and generate an (n+1)th training set of the first model based on the training data and the (n+1)th second label information; and
perform an (n+1)th round of training on the second model by inputting the (n+1)th training set of the second model to the second model, and perform the (n+1)th round of training on the first model by inputting the (n+1)th training set of the first model to the first model.

12. The electronic equipment of claim 11, wherein the processor is adapted to:
determine whether the n is less than N, the N being a maximal number of rounds of training,
wherein the processor is adapted to acquire the (n+1)th first label information output by the first model and acquire the (n+1)th second label information output by the second model by:
in response to the n being less than the N, acquiring the (n+1)th first label information output by the first model and acquiring the (n+1)th second label information output by the second model.

13. The electronic equipment of claim 11, wherein the processor is adapted to:
acquire the training data and initial label information of the training data; and
generate a first training set of the first model and a first training set of the second model based on the initial label information.

14. The electronic equipment of claim 13,
wherein the processor is adapted to acquire the training data and the initial label information of the training data by:
acquiring a training image containing a plurality of segmentation target, and acquiring a circumscribing frame circumscribing the segmentation target,
wherein the processor is adapted to generate the first training set of the first model and the first training set of the second model based on the initial label information by:
based on the circumscribing frame, drawing, inside the circumscribing frame, a label contour shaped like the segmentation target; and
generating the first training set of the first model and the first training set of the second model based on the training data and the label contour.

15. The electronic equipment of claim 14, wherein the processor is adapted to generate the first training set of the first model and the first training set of the second model based on the initial label information by:
generating, based on the circumscribing frame, a segmentation boundary between two of the segmentation target that overlap each other; and
generating the first training set of the first model and the first training set of the second model based on the training data and the segmentation boundary.

16. The electronic equipment of claim 14,
wherein the processor is adapted to, based on the circumscribing frame, draw, inside the circumscribing frame, the label contour shaped like the segmentation target, by:
based on the circumscribing frame, drawing, inside the circumscribing frame, an inscribed ellipse inscribed in the circumscribing frame, the inscribed ellipse being shaped like a cell.

17. The electronic equipment of claim 12, wherein the processor is adapted to:
acquire the training data and initial label information of the training data; and
generate a first training set of the first model and a first training set of the second model based on the initial label information.

18. The electronic equipment of claim 17,
wherein the processor is adapted to acquire the training data and the initial label information of the training data by:
acquiring a training image containing a plurality of segmentation target, and acquiring a circumscribing frame circumscribing the segmentation target,
wherein the processor is adapted to generate the first training set of the first model and the first training set of the second model based on the initial label information by:
based on the circumscribing frame, drawing, inside the circumscribing frame, a label contour shaped like the segmentation target; and
generating the first training set of the first model and the first training set of the second model based on the training data and the label contour.

19. The electronic equipment of claim 18, wherein the processor is adapted to generate the first training set of the first model and the first training set of the second model based on the initial label information by:
generating, based on the circumscribing frame, a segmentation boundary between two of the segmentation target that overlap each other; and
generating the first training set of the first model and the first training set of the second model based on the training data and the segmentation boundary.

20. A non-transitory computer-readable storage medium, having stored thereon computer-executable instructions which, when executed, implement:
acquiring (n+1)th first label information output by a first model, the first model having been subject to n rounds of training, and acquiring (n+1)th second label information output by a second model, the second model having been subject to n rounds of training, the n being an integer greater than 1;
generating an (n+1)th training set of the second model based on training data and the (n+1)th first label information, and generating an (n+1)th training set of the first model based on the training data and the (n+1)th second label information; and
performing an (n+1)th round of training on the second model by inputting the (n+1)th training set of the second model to the second model, and performing the (n+1)th round of training on the first model by inputting the (n+1)th training set of the first model to the first model.
